(19) United States
(12) Patent Application Publication
(10) Pub. No.: US 2019/0364738 A1
(43) Pub. Date: Dec. 5, 2019

(54) BALE EJECTION DEVICE AND BALER

(71) Applicant: DEERE & COMPANY, Moline, IL (US)

(72) Inventor: PASCAL PEGON, ARC LES GRAY (FR)

(21) Appl. No.: 16/379,822

(22) Filed: Apr. 10, 2019

(30) Foreign Application Priority Data
May 29, 2018 (DE) 102018208442.4

(51) Int. Cl. A01F 15/08; B30B 9/30; A01F 15/04

(52) U.S. Cl. CPC A01F 15/0875; A01F 15/042; B30B 9/3014

(57) ABSTRACT

A bale ejection device for a baler for forming a bale includes a square bale chamber, a plunger having a packing face turned toward the bale accommodated within the chamber for movement, and at least one ejection ram selectively disposed at a position in which it projects beyond the packing face.

### RELATED APPLICATIONS

This application claims priority to German Patent Application Ser. No. 102018208442.4, filed May 29, 2018, the disclosure of which is hereby incorporated by reference in its entirety.

### FIELD OF THE DISCLOSURE

The present disclosure relates to a bale ejection device for a baler for formation of packed bales in a square bale chamber, in which a piston with a packing surface turned toward the bale is accommodated so that it can move, and a baler for formation of packed bales in a square bale chamber in which a piston is accommodated so that it can move.

### BACKGROUND

Known bale ejection devices are used in balers that have a square bale chamber in order to contribute to a packed bale formed in the bale chamber of the baler in the form of a square bale to be transported out from the bale chamber. This can be particularly desirable if the bale chamber is supposed to be completely emptied after the end of the harvesting operation. Transport means that slide in the bale chamber and are able to engage the packed bale from above or from the sides in order to transport it in the direction of a discharge opening are usually provided for this. The bale ejection devices are used both in agriculture and industry in balers with square bale chambers. The corresponding agricultural balers serve, for example, to form crop bales from crop such as in the form of straw, hay, forage material, etc. Industrial balers are used in the compaction of waste, textiles, or other substances, or in the compaction of such substances into bales. With the known bale ejection devices, it may happen, in particular under difficult harvesting conditions, that the bales are not optimally ejected from the bale chamber.

### SUMMARY

In the present disclosure, a bale ejection device for a baler for formation of packed bales in a square bale chamber, in which a plunger with a packing face turned toward the bale is accommodated so that it can move, has at least one ejection ram which can selectively take at least one position in which it projects beyond the packing surface. If the ejection ram takes the position, this selectively or temporarily increases the stroke of the plunger. In this way, the bale, in particular a completely tied bale or even an only partly completed bale, which in what follows is also called a flake, can be transported farther in the direction of a discharge opening of the bale chamber or a depositing device.

If the ejection ram is disposed in the plunger or a packing element of the plunger, it does not require any additional space. Moreover, if the ejection ram is mounted at one end, in particular however is fixed in position on the packing element or the plunger, this will simplify the mounting of the ejection ram or the ejection ram will be able to move together with the plunger so that the plunger, in order to achieve a stroke that is as long as possible, can take a position that extends out of the bale chamber when the ejection ram projects beyond the packing surface.

It may be desirable if the ejection ram is designed so that it can move in a translatory or telescopic manner at least over an area, in particular with respect to the plunger.

If the packing face has at least two segments, this can favor a modular construction of the plunger. If the faces are separated by an at least essentially vertical slot, movable components of the baler, for example, needles or a needle or binding assembly of the baler, can engage in the slot in order to bind a bale with a binding material, for example, twine or a similar material.

If the packing surface or at least one of the segments comprises a movable segment, the segment can be effectively connected to the ejection ram so that the segment moves together with the ejection ram or the segment is moved by the ejection ram, in particular so that the segment can be brought into a position in which it projects beyond the packing surface as such.

It is conceivable that the bale ejection device can be manually operated. However, it is possible if there is at least one discharge motor, e.g., a hydraulic motor having a cylinder and a discharge piston that moves in the cylinder, which interacts directly or indirectly with the ejection ram.

It is further possible if a baler form forming bales in a square bale chamber in which a plunger is accommodated so that it can move has a bale ejection device. The baler may be an agricultural baler for formation of square bales. The baler can, however, also be used in the industrial field, for example, for formation of bales of paper, waste, cloth, or other materials.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 shows a side view of a baler for formation of packed bales in a square bale chamber,

FIG. 2 shows an enlarged view of a plunger of the baler with a bale ejection device, and

FIG. 3a-d schematically shows the plunger and the bale ejection device in different positions.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

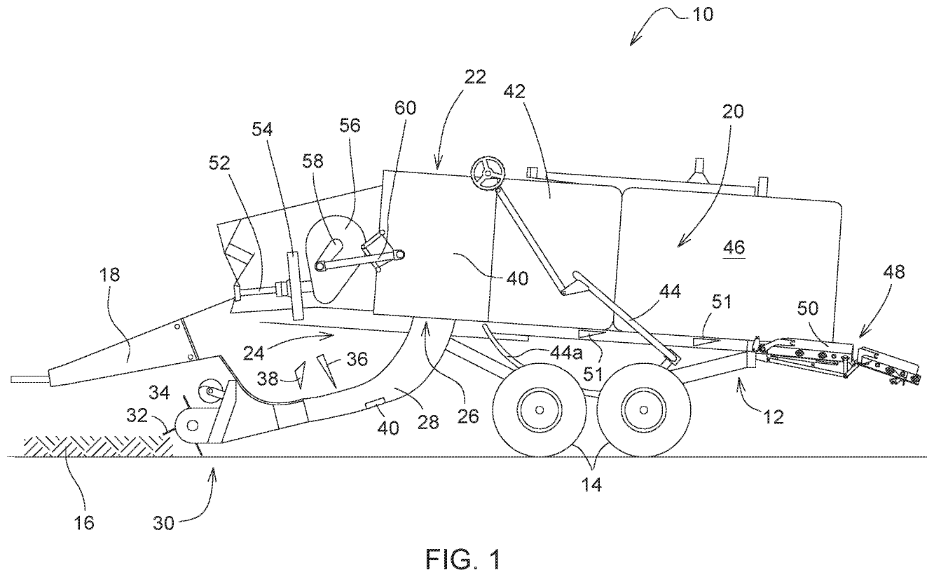

FIG. 1 shows a baler 10 for production of square bales having a chassis 12, which is supported on the ground 16 via wheels 14 in a tandem arrangement. A drawbar 18 is connected to the chassis 12 and extends forward from it and is designed so that it can be connected to a utility vehicle (not shown), for example, a tractor. The baler 10 has a bale chamber 20 in the form of a chamber with a rectangular cross section, which is formed by a housing 22. In a lower region 24, the housing 22 is provided with a material inlet 26, to which a curved feed channel 28 is connected.

Moreover, a crop pickup device 30 is provided in the form of a pickup 32 with an associated lower mount 34, a packer fork 36, and a stuffer fork 38. The crop pickup device 30 is disposed in front of the feed channel 28, in order to pick up crop from the ground and feed it to the packer fork 36 which serves to compact the crop in the feed channel 28 until a charge of preselected density has collected in the feed channel 28 and is shoved into the bale chamber 20 via the material inlet 26 by the stuffer fork 38. A spring-loaded flap 39 is pivoted at a front lower point of the feed channel 28 and pivots in dependence on the density of the crop in the feed channel 28 and indicates as soon as a desired flake density is achieved in the feed channel 28 so that the stuffer fork 38 becomes activated in order to move a portion of crop into the bale chamber 20.

When the charge of crop has been brought into the bale chamber 20, a plunger 40 is actuated by means of a suitable drive in a controlled sequence timed with the stuffer fork 38 so as to move the crop toward the rear in the bale chamber 20, where it becomes packed in a stack of flakes 42. After the stack 42 of packed material has reached a selected length, a needle assembly 44 for providing binding twine, which contains a plurality of curved needles 44a, is actuated so as to feed a plurality of strands of twine to a corresponding number of knotters (not shown), which operate to lay the twine strands around the selected length of the stacks 42 in order to form a bale 46. A depositing device 50, via which the bales 46 can be deposited on the ground 16, is mounted in a rear end region 48 of the chassis 12. Moreover, upstream from the depositing device 50, a bale ejection means or mechanism 51 is provided in the lower region 24 on the chassis. The bale ejection means or mechanism is disposed so that it can pivot upward and can slide in the lengthwise direction of the bale chamber 20, in a known manner and way, and so it can engage the bale 46 or the stack 42 in order to transport it in the direction of the depositing device 50, in particular when the bale chamber 20 is to be completely emptied after the end of a harvesting operation. The bale ejection means or mechanism 51 may including one or more bale ejection means or mechanism.

The plunger 40 is designed for a back and forth movement in the bale chamber 20 between a retracted position in front of the material inlet 26 and a partially extended position (shown in FIG. 1) beyond the material inlet 26, from which it can move still farther to the rear until it hits the stack 42 or the bale 46 and [the bale] becomes packed. The plunger 40 is driven by an input shaft 52, which, for example, can be driven by a power take-off of the utility vehicle (not shown). The input shaft 52 drives a flywheel 54 and, via a transmission 56, a crank 58, the movement of which is transmitted to the plunger 40 via a connecting rod 60.

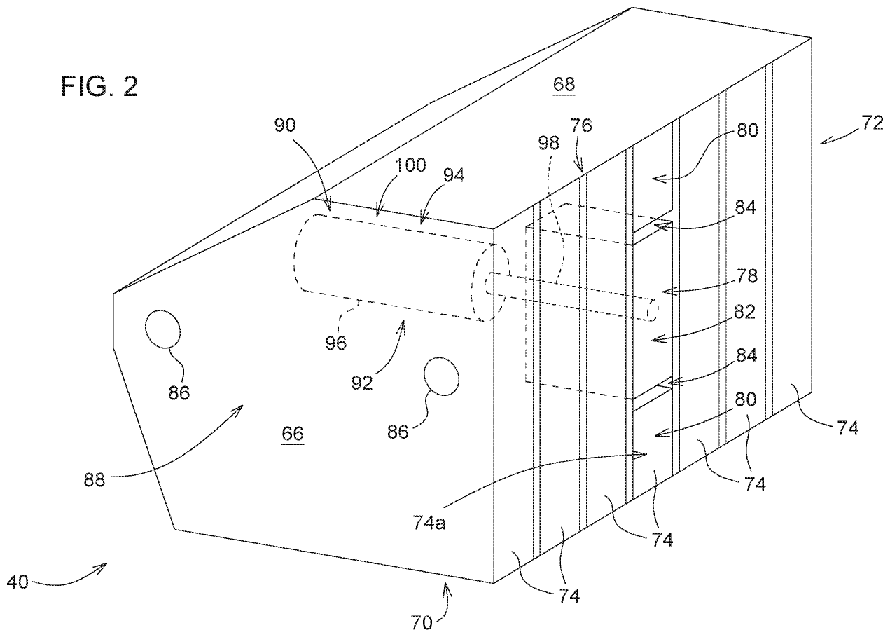

Referring to FIG. 2, according to which the plunger 40 has a packing element 64 with two side walls 66, a top surface 68, a bottom surface 70, and a packing face 72, which is turned toward the bale 46 during operation. The packing face 72 in turn has a plurality of segments 74, six in the illustrated embodiment of FIG. 2, which are separated by horizontal slots 76 in which the needles 44a of the needle assembly 44 can engage during the binding of the bale 46.

One of the segments 74, which is called segment 74a in what follows and which is disposed in a central region 78 of the packing face 72, is additionally divided horizontally and has two outer segments 80, which are fixed in position with respect to the other segments 74 or to the press element 64, and a central movable segment 82. The segments 80 and the movable segment 82 are separated by gaps 84. Guide elements 86, which are turned toward the bale chamber 20 and by means of which the plunger 40 is guided horizontally in the bale chamber 20, are provided on the side walls 66.

Moreover, a bale ejection device 88 with an ejection ram 92 disposed in an inner region 90 of the packing element 64 is provided, where the ejection ram 92 engages the movable segment 82 at one end and the packing element 64 at the other. The ejection ram 92 is telescopically extendable and for this has an ejection motor 100 designed as a hydraulic motor 94 with a cylinder 96 and an ejection piston 98 that can move in the cylinder 96.

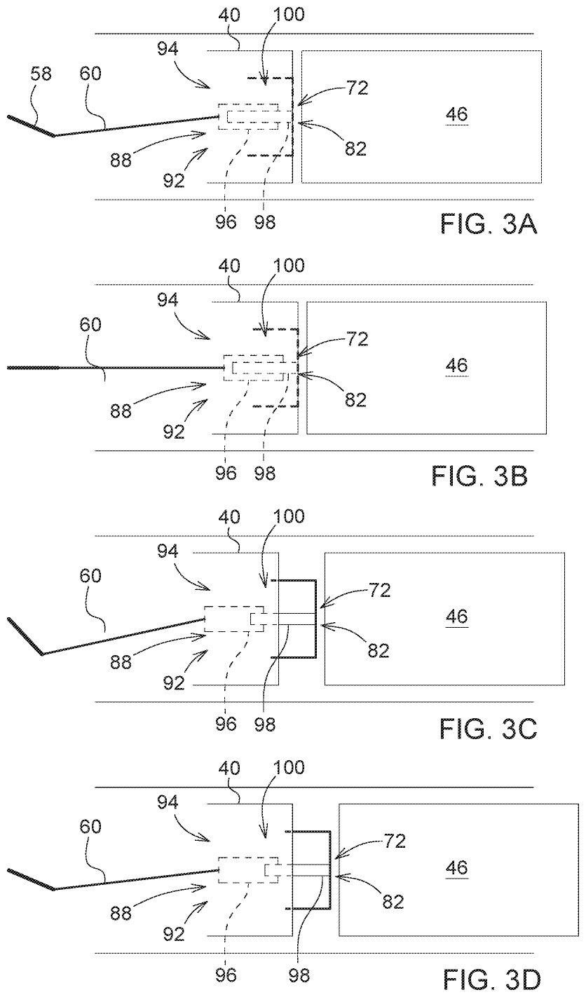

Reference is now made to FIGS. 3a-d where the plunger 40 and the ejection ram 92 are shown in different positions. In FIG. 3a, the plunger 40 is shown just before the end of a packing stroke from which it is brought into the fully extended position shown in FIG. 3b following packing of the bale 46 or stack 42. If the bale 46 or the stack 42 that has not yet been tied into a bale 46 is to be ejected from the bale chamber 20, the plunger 40 is brought from the completely extended position back into its retracted position, where the discharge motor 100 is controlled manually, for example, or even automatically via a control device (not shown) of the baler 10. Alternatively, it may be supplied with hydraulic pressure so that the ejection piston 98 moves out with respect to the cylinder 96 and thus the ejection ram 92 and together with it the movable segment 82 of the segment 74a projects out beyond the packing face 72 (FIG. 3c). In this way, the stroke of the plunger 44 is increased in the next cycle of movement so that the bale 46 or the stack 42 can be transported farther in the direction of the discharge device 50 (FIG. 3d). This can optionally be supported by the action of the discharge means 51.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A bale ejection device for a baler for forming a bale, comprising:
a square bale chamber;
a plunger having a packing face turned toward the bale accommodated within the chamber for movement; and
at least one ejection ram selectively disposed at a position in which it projects beyond the packing face.

2. The bale ejection device of claim 1, wherein the ejection ram is disposed in the plunger or a press element of the plunger.

3. The bale ejection device of claim 2, wherein the ejection ram is mounted at one end of the plunger or press element.

4. The bale ejection device of claim 2, wherein the ejection ram is fixedly mounted to the plunger.

5. The bale ejection device of claim 1, wherein the ejection ram is provided at least over an area to be movable in a translatory or telescopic manner with respect to the plunger.

6. The bale ejection device of claim 1, wherein the packing face comprises at least two segments separated by slots extending partially vertically.

7. The bale ejection device of claim 1, wherein the packing face is connected to the ejection ram.

8. The bale ejection device of claim 1, wherein the packing face comprises at least two segments, where at least one of the segments has a movable segment.

9. The bale ejection device of claim 1, further comprising a discharge motor for operably driving the ejection ram.

10. The bale ejection device of claim 9, wherein the discharge motor comprises a hydraulic motor including a cylinder and an ejection piston that moves in the cylinder.

11. A baler for forming a bale, comprising:
a square chamber;
a plunger having a packing face turned toward the bale accommodated within the chamber for movement; and
a bale ejection device comprising at least one ejection ram selectively disposed at a position in which it projects beyond the packing face.

12. The baler of claim 11, wherein the ejection ram is disposed in the plunger or a press element of the plunger.

13. The baler of claim 12, wherein the ejection ram is mounted at one end of the plunger or press element.

14. The baler of claim 12, wherein the ejection ram is fixedly mounted to the plunger.

15. The baler of claim 11, wherein the ejection ram is provided at least over an area to be movable in a translatory or telescopic manner with respect to the plunger.

16. The baler of claim 11, wherein the packing face comprises at least two segments separated by slots extending partially vertically.

17. The baler of claim 11, wherein the packing face is connected to the ejection ram.

18. The baler of claim 11, wherein the packing face comprises at least two segments, where at least one of the segments has a movable segment.

19. The baler of claim 11, further comprising a discharge motor for operably driving the ejection ram.

20. A baler for forming a bale, comprising:
a chassis;
a bale chamber formed by a housing, the housing comprising an inlet and a feed channel;
a pickup device disposed in front of the feed channel for collecting crop and feeding it to the feed channel;
a plunger having a packing face turned toward the bale accommodated within the bale chamber for movement; and
a bale ejection device comprising at least one ejection ram selectively disposed at a position in which it projects beyond the packing face.
